(19) United States
(12) Patent Application Publication
(10) Pub. No.: US 2006/0058408 A1
(43) Pub. Date: Mar. 16, 2006

(54) Isocyanate composition and its use in the preparation of expanded polyurethane with improved physico-mechanical properties

(76) Inventors: Felix Okon Sam, Ponte San Nicolo (IT); Luca Fideli, Somma Lombardo (IT)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/468,556

(22) PCT Filed: Feb. 22, 2002
(86) PCT No.: PCT/EP02/01898

§ 371 Date: Apr. 12, 2004

(30) Foreign Application Priority Data
Feb. 22, 2001 (IT) MI2001A000357

(51) Int. Cl. C08G 18/00; C08G 18/02

(52) U.S. Cl. 521/155; 528/44

(57) ABSTRACT

Isocyanate compositions with isocyanate functionality between 2.2 and 2.9 which include: a) 20 to 80% by weight of the reaction product of methylene diphenyl isocyanate (MDI) with an ethylene oxide (EO)/propylene oxide (PO) polyether polyol of functionality 2 to 8, an average molecular weight of 200 to 6000, and an ethylene oxide content of 20 to 90% having a free NCO group content of 26 to 33% by weight; and 20 to 80% by weight of an MDI polymer.

The invention concerns certain isocyanate compositions and their use in the preparation of flexible expanded polyurethanes which have improved physico-mechanical properties.

More specifically, the invention concerns certain methylene diphenyl isocyanate (MDI)-based isocyanate compositions and their use in the preparation of flexible expanded polyurethanes which have improved physico-mechanical properties.

The term “flexible expanded polyurethanes which have improved physico-mechanical properties”, as used in this description and in the claims refers to expanded polyurethanes or polyurethane foams including those suitable for use for slabs, in molding (cold and hot) and for integral skin with a density preferably up to 50 kg/m³ or, more preferably, between 25 and 50 kg/m³, a compression resistance at 40% deflection, measured according to DIN-EN-ISO 3386-98, suitably greater than 3 kPa and optimally, a permanent deformation, or compression set tested according to ISO 1856-80 of lower than about 15% and preferably lower than 10%.

In certain fields, for example for furniture and in the automotive industry, it is desirable that products made from flexible expanded polyurethanes or polyurethane foams, both slab and molded, have good comfort properties and physico-mechanical properties. In general, attainment of such properties does not require particular steps to be taken for high-density (≧55 kg/m³) foams, whereas medium to low density (25 to 45 kg/m³) foams typically require the use of secondary expanding agents combined with a primary expanding agent for example water in the expansion stage, in order to overcome processability problems, especially in the case of lower-density products. Halogenated hydrocarbons have been used for many years as secondary expanding agents, in particular chlorofluoroalkanes such as FREON 11 (trichlorofluoromethane), because of their ease of availability, their compatibility with polyurethane reagents and because of their properties as expanding agents.

However, with the phase out of chlorofluoro alkanes, following the 1987 Montreal Protocol which sought to limit the use and production of products implicated in the depletion of the stratospheric ozone layer, other procedures for obtaining low-density polyurethane foams with good physico-mechanical properties with water as the only expanding agents have been developed, for instance as described in EP-A-486,034. Other expanding agents are used in EP 477,920.

The Applicant has now found certain MDI-based isocyanate compositions which provide medium-low density expanded polyurethanes, having excellent comfort and physico-mechanical properties, using only water as the expanding agent. In addition, the isocyanate compositions of the invention are surprisingly stable and have an excellent “shelf-life”.

The invention provides an isocyanate composition having an isocyanate functionality of 2.2 to 2.9 which comprises:
a) 20 to 80% by weight, preferably 40 to 60%, of the reaction product of methylene diphenyl isocyanate (MDI) with at least one polyether polyol comprising ethylene oxide (EO) and propylene oxide (PO) with a functionality of 2 to 8, an average molecular weight of 200 to 6000, preferably 500 to 2500, and an ethylene oxide content of 20 to 90% by weight, preferably 50 to 75% or 80% and especially 70 to 80% and in which said reaction product has a free NCO group content of 26 to 33% by weight and preferably 29 to 33%; and
b) 10 to 80% by weight, preferably 20 to 80%, more preferably 40 to 60% and especially 40 to 50% of a polymeric methylene diphenyl isocyanate having a general formula (I): 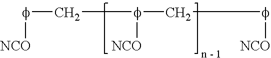
where Φ represents a phenyl group and n is a whole number greater than or equal to 1.

More specifically, the invention provides an isocyanate composition having an isocyanate functionality of 2.2 to 2.9 which comprises, and preferably consists essentially of;
a) 30 to 70% by weight, preferably 40 to 60% of the reaction product of methylene diphenyl isocyanate with at least one polyether polyol comprising ethylene oxide (EO) and propylene oxide (PO) with a functionality of 2 to 8, an average molecular weight of 400 to 6000, preferably 600 to 2500, and an ethylene oxide content of 20 to 90% by weight, preferably 50 to 75% or 80% and especially 70 to 80% and in which said reaction product has a free NCO group content of 26 to 33% by weight and preferably 29 to 33%;
b) 10 to 70% by weight of a polymeric methylene diphenyl isocyanate having a general formula (I): 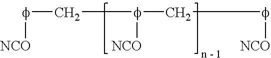
where Φ represents a phenyl group and n is a whole number greater than or equal to 1; and
c) 5 to 30% by weight, preferably 10 to 20% of uretonimine modified methylene diphenylisocyanate.

In a preferred embodiment, the invention provides an isocyanate composition having an isocyanate functionality of 2.2 to 2.9, which comprises, and preferably consists essentially of;
a) 20 to 80% by weight, preferably 40 to 60%, of the reaction product of MDI with a mixture comprising a first polyether polyol having an average molecular weight of 1000 to 6000, preferably 1500 to 2500, and a second polyether polyol having an average molecular weight of less than 1000, wherein the first and second polyols, independently comprise ethylene oxide and propylene oxide with a functionality of 2 to 8, and an ethylene oxide content of 20 to 90% by weight, preferably 50 to 75% or 80% and especially 70 to 80% and the second polyether polyol is present at a concentration of less than 50% by weight relative to the first polyol and in which said reaction product has a free NCO group content of 26 to 33% by weight and preferably 29 to 33%; and
b) 20 to 80% by weight, preferably 40 to 60%, of a polymeric methylene diphenyl isocyanate having a general formula (I): 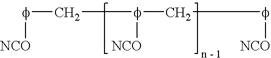
   where Φ represents a phenyl group and n is a whole number greater than or equal to 1.

In another embodiment, the polyol to be reacted with the methylene diphenyl isocyanate may be reacted with the MDI and the polymeric MDI of formula (I) together to produce an isocyanate composition.

The invention further provides an isocyanate composition having an isocyanate functionality of 2.2 to 2.9 which comprises the reaction product obtained by reacting a mixture of methylene diphenyl isocyanate (MDI) comprising 20 to 30% 2,4′-methylene diphenyl isocyanate based on the total amount of MDI and a polymeric methylene diphenyl isocyanate having a general formula (I): 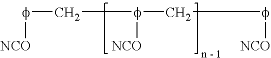
where Φ represents a phenyl group and n is a whole number greater than or equal to 1 with at least one polyether polyol comprising ethylene oxide (EO) and propylene oxide (PO) with a functionality of 2 to 8, an average molecular weight of 200 to 6000, preferably 500 to 2500, and an ethylene oxide content of 20 to 90% by weight, preferably 50 to 75% or 80% and especially 70 to 80%.

Suitable polymeric MDI's, according to the subject invention include polymethylene polyphenyl polyisocyanates with average functionality of 2.6 to 2.8; said products are available under various names such as “TEDIMON 31” (Enichem S.p.A.), “SUPRASEC DNR” (Huntsman), “VORANATE M-220” (Dow) and DESMODUR 44 V20 (Bayer). Uretonimine MDI-modified is a reaction product of methylenediphenyl isocyanate with an excess of a carbodiimide derivative.

Preferably, MDI used in the preparation of isocyanate prepolymer (a) comprises a mixture of the 4,4′ and 2,4′ isomers, in which the 2,4′ isomer concentration is from 10 to 60% by weight, preferably from 18 to 50% and especially from 20% to 30% based on the total amount of MDI.

The polyether polyol employed to produce the reaction product with MDI and optionally polymeric MDI to produce an isocyanate composition according to the invention suitably has a hydroxyl functionality of 2 to 8. Polyether diols, that is polyether polyols, having a functionality of 2 may be expected to impart good elongation properties to polyurethane foams produced therefrom due to the absence of cross-linking associated with polyether polyols having a functionality of 3 or higher but also poor compression set and dynamic fatigue characteristics, for example a high level of % thickness loss and compression load loss when tested under Peugeot test method D42.1047-84.

It has been found that polyisocyanate compositions according to the invention in which the polyether polyol has a functionality of 2 provide good elongation properties but surprisingly exhibit excellent dynamic fatigue properties as well.

Accordingly, a further preferred embodiment of the invention provides an isocyanate composition having an isocyanate functionality of 2.2 to 2.9, which comprises, and preferably consists essentially of;
a) 20 to 80% by weight, preferably 40 to 60% of the reaction product of methylene diphenyl isocyanate with at least one polyether polyol comprising a polyether diol (having a functionality of 2) which comprises ethylene oxide (EO) and propylene oxide (PO), an average molecular weight of 400 to 6000, preferably 600 to 2500, and an ethylene oxide content of 20 to 90% by weight, preferably 50 to 75% or 80% and especially 70 to 80% and in which said reaction product has a free NCO group content of 26 to 33% by weight and preferably 29 to 33%; and
b) 20 to 80% by weight, preferably 40 to 60%, of a polymeric methylene diphenyl isocyanate having a general formula (I): 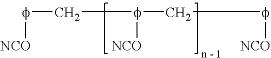
where Φ represents a phenyl group and n is a whole number greater than or equal to 1.

Desirably the polyether diol in this embodiment comprises ethylene oxide (EO) and propylene oxide (PO), an average molecular weight of 400 to 6000, preferably 600 to 2500. Preferably the polyether diol has an ethylene oxide content of 50 to 75% or 80% and especially 70 to 80%.

Suitably MDI used in combination with the polyether diol comprises a mixture of the 4,4′ and 2,4′ isomers, in which the isomer 2,4′ concentration is from 18 to 50% and especially from 20% to 30% based on the total amount of MDI.

Polyisocyanate compositions comprising a reaction product of MDI with 20 to 30% of the 2,4′-MDI isomer and a polyether diol as described herein and wherein the reaction product has a free NCO group content of 29 to 33% are especially preferred. Optionally the MDI may be mixed with a polymeric MDI of formula I as described herein prior to reaction with the polyether diol to form the reaction product.

A further aspect of the invention provides a process for the preparation of a flexible expanded polyurethane with improved physico-mechanical properties which comprises reacting together:
i) an isocyanate composition having an isocyanate functionality of 2.2 to 2.9 which comprises:
a) 20 to 80% by weight, preferably 40 to 60%, of the reaction product of methylene diphenyl isocyanate (MDI) with at least one polyether polyol comprising ethylene oxide (EO) and propylene oxide (PO) with a functionality of 2 to 8, an average molecular weight of 200 to 6000, preferably 500 to 2500, and an ethylene oxide content of 20 to 90% by weight, preferably 50 to 75% or 80% and especially 70 to 80%, and in which said reaction product has a free NCO group content of 26 to 33% and preferably 29 to 33% by weight; and
b) 20 to 80% by weight, preferably 40 to 60%, of a polymeric methylene diphenyl isocyanate having a general formula (I): 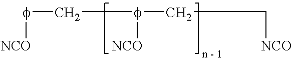
where Φ represents a phenyl group and n is a whole number greater than or equal to 1; and
ii) a polyol component comprising at least one polyol, with a functionality of 2 to 8 and an equivalent weight of 200 to 2000 and water.

Preferably, the expanded polyurethane foam is prepared using an isocyanate composition preferred herein, in particular, a polyisocyanate composition comprising a reaction product of MDI with 20 to 30% of the 2,4′-MDI isomer and a polyether diol as described herein and wherein the reaction product has a free NCO group content of 29 to 33%. Optionally the MDI may be mixed with a polymeric MDI of formula I as described herein prior to reaction with the polyether diol to form the reaction product. Polyurethanes produced employing a preferred isocyanate composition suitably exhibit a % thickness loss of less than 5% and preferably less than 3% and a % compression resistance loss of less than 16% when tested under Peugeot Test Method D42.1047-84.

The at least one polyol and the polyol to be reacted with the isocyanate composition may be the same. Optionally the MDI and the polymeric MDI are reacted with the polyol polyether to produce the expanded polyurethane in a single step.

The invention further provides, use of an isocyanate composition according to any one of claims in the preparation of an expanded polyurethane having a density up to 50 Kg/m³, a bearing capacity greater than 40 N, preferably greater than 200N and more preferably from 80 to 400 N according to ISO 2439-97, a % thickness loss of less than 5% and a % compression resistance loss of less than 16% when tested under Peugeot Test Method D42.1047-84.

The polyol used in the preparation of flexible expanded polyurethanes according to the process may be selected from polyether polyols, polyether polyols containing ester groups, polyether polyols containing amine groups, polyester polyols, and the like. Preferred polyols include polyether polyols obtained through condensation of olefinic oxides having from 2 to 6 carbon atoms on (starter) compounds having at least two atoms of active hydrogen. The preferred olefinic oxides are ethylene oxide (EO) and propylene oxide (PO), and compounds which may provide EO or PO units in the polyether polyol.

Suitable starter compounds include glycols, triols, tetrols, amines, alkanolamines, polyamines and the like and mixtures thereof.

In a preferred embodiment, the polyether polyol suitably comprises ethylene oxide and/or propylene oxide and the starter is selected from a glycol, for example dipropylene glycol, a triol for example glycerin and trimethylolpropane, a tetrol for example pentaerythritol, a diamine for example ethylene diamine, an aromatic amine for example ortho-toluene diamine, an alkanol amine for example triethanolamine, and a polyfunctional hydroxyl alkane for example xylitol, arabitol, sorbitol and mannitol.

The polyol may be used as is, or may contain solid particles, preferably polymeric particles. The particles are suitably in dispersion or partially linked to polyol chains, with dimensions under 20 micrometers. Polymers especially suitable for this purpose include polyacrylonitrile, polystyrene, polyvinyl chloride, copolymers comprising any of these polymers, and, urea-based polymers. Said solid particles may be prepared for polymerization in situ in the polyol or be prepared separately and later added to the polyol.

The polyol compound may also include one or more additives commonly used in the preparation of expanded polyurethanes as amine catalysts, such as triethylendiamine, and/or metallic such as stannous octoate, cell regulators, thermo-oxidation stabilizers, pigments and the like. Details on polyurethane polymerization are described in “Saunders & Frisch—Polyurethanes, Chemistry and Technology” Interscience, New York, 1964.

In the production of an expanded polyurethane according to the process of this invention, the expanding agent suitably comprises water. Water may be used alone or combined with secondary expanding agents other than the chlorofluoro alkanes and preferably water is present at a higher level than any other expanding agents. Water has a critical function in the preparation of expanded polyurethanes since through it urea bonds are formed, associated to the development of carbon dioxide which triggers the polyurethane resin expansion/swelling process thus obtaining flexible expanded polyurethanes. Suitably water is present in an amount from 3 to 6 parts by weight to 100 parts of polyol compound.

Carbon dioxide is suitably used to expand polyurethane resin, preferably as a primary agent developed in situ by reacting water and the polyisocyanate NCO groups.

In the preparation of reduced-density expanded polyurethanes, for example, having a density equal to or lower than 25 Kg/m³, the expanding function of carbon dioxide from water alone may not be sufficient to reach the desired density without incurring problems (burning or “scorching”) due to the exothermal reaction of water with the diisocyanate groups. For this reason, a secondary expanding agent in addition to water may be used.

Suitable secondary expanding agents include air, liquid or gaseous CO₂, nitrogen, alkane hydrofluorides with low or zero ozone depletion potential, hydrocarbons for example n-pentane, i-pentane, and cyclopentane, dimethyl carbonate and mixtures thereof. Whilst the primary expanding agent in the polymerization mass is preferably generated in situ, external introduction of the primary and/or secondary expanding agent may also be employed, for example injection.

The flexible expanded polyurethanes obtained according to the present process suitably have a density of 25 to 50 Kg/m³ or lower at core, and a bearing capacity (as per ISO 2439 norm) greater than 40 N and preferably 80 to 400 N. These polyurethanes advantageously do not exhibit thermo-oxidation degradation phenomena, such as scorching, and also possess excellent mechanical properties, such as elongation at breakage, permanent deformation, compression resistance and air permeability. Due to these characteristics, the foams derived from the subject invention may beneficially be used in various fields including in the furniture and/or decorating sector and the transportation and/or automotive industries which typically require materials with the above-mentioned properties.

The invention is illustrated by the following non-limiting examples.

### EXAMPLE 1

An isocyanate compound is prepared by reacting 42 parts by weight of a mixture of 4,4′-MDI/2,4′-MDI in the ratio of 80/20; 14.0 parts by weight of a mixture of 4,4′-MDI/2,4′-MDI in the ratio of 50/50, with an ethylene oxide-based polyether polyol and propylene oxide with an average molecular weight of 2500 in which the EO/PO ratio is 75/25 (EniChem's Nixolen VS 40). At the end of the reaction performed at 70° C. for approximately 2 hours, a prepolymer is obtained with a 30.1 percentage of free NCO. 40 parts by weight of Polymeric MDI (TEDIMON 31) are then added to the prepolymer until a 30.5 percentage of free NCO is obtained.

### EXAMPLE 2

An isocyanate compound is prepared by reacting 55 parts by weight of a 4,4′-MDI/2,4′-MDI mixture in the ratio of 80/20; 8 parts by weight of a 4,4′-MDI/2,4′-MDI mixture in the ratio of 50/50, with Nixolen VS 40 and an ethylene oxide-based polyether polyol with an average molecular weight of 600 (Enichem's Priowax 600). At the end of the reaction, performed at 70° C. for approximately 2 hours a prepolymer is obtained to which Polymeric MDI (TEDIMON 31) is then added until a percentage of 30.4 free NCO is obtained.

### EXAMPLE 3

An isocyanate compound is prepared by reacting 50 parts by weight of a 4,4′-MDI/2,4′-MDI mixture in 80/20 ratio; 10 parts by weight of a 4,4′-MDI/2,4′-MDI mixture in a 50/50 ratio, 10 parts of uretonimine modified MDI (TEDIMON 318 by the Applicant) with an ethylene oxide-based polyether polyol and propylene oxide with an average molecular weight of 4000 in which the EO/PO ratio is 20/80 (TERCAROL 838). At the end of the reaction, performed at 70° C. for approximately 2 hours, a prepolymer is obtained with a 29.9 percentage of free NCO.

Polymeric MDI (TEDIMON 31) is then added to the prepolymer until a 30.5 percentage of free NCO is obtained.

### EXAMPLES 4 to 6

The compounds in Examples 1 to 3 were used for the preparation of flexible expanded polyurethanes combined with the polyol components listed in the Table below. The same Table shows the physico-mechanical properties of the foams thus obtained.

The dynamic fatigue properties of the foams tested in Examples 4 to 6 were measured according to Peugeot test method D42.1047-84. The 50% permanent deformation data, (compression set) was measured according to ISO 1856-80. The compression resistance data or compression force deflection was measured according to DIN EN ISO 3386-1-98. The bearing capacity or indentation force deflection was measured according to ISO 2439-97 and the foam density was measured according to DIN EN ISO 845-95.

TABLE

| Example | 4 | 5 | 6 |
|---|---|---|---|
| Tercarol 427 | 100 | 100 | 100 |
| Tercarol 241 | 1.5 | 1.5 | 1.5 |
| XD7436 | 2.0 | 2.0 | 2.0 |
| DEOA | 0.5 | 0.5 | 0.5 |
| Water, pp | 3.7 | 3.7 | 3.7 |
| NIAX A 107, pp | 0.2 | 0.2 | 0.2 |
| NIAX A 310, pp | 0.2 | 0.2 | 0.2 |
| POLYCAT 77, pp | 0.15 | 0.15 | 0.15 |
| NIAX L 3410, pp | 1.0 | 1.0 | 1.0 |
| ISOCYANATE Example 1 | 95 | — | — |
| (index) | | | |
| ISOCYANATE Example 2 | — | 95 | — |
| (index) | | | |
| ISOCYANATE Example 3 | — | — | 95 |
| (index) | | | |
| Density, kg/m³ | 43 | 44.5 | 45 |
| Perm. Deformation 50%, | 4.5 | 4.8 | 5.5 |
| % (compression set) | | | |
| Comp resistance. 40%, | 7.5 | 7.2 | 6.4 |
| kPa | | | |
| Bearing capacity 40%, N | 320 | 294 | 233 |
| Dynamic Fatigue | | | |
| % Thickness loss | 2.1 | 2.2 | 1.9 |
| % Compression | 11.5 | 13.3 | 15.2 |
| resistance loss | | | |

TERCAROL ® 241 - Polyether polyol PM 4000 with functionality = 3
TERCAROL ® 427 - Polyether polyol PM 6000 with functionality = 3
XD 7436 - crosslinker
NIAX A 107 - Witco Corporation aminated Catalyst
NIAX A 310 - Witco Corporation aminated Catalyst
NIAX L 3410 - Witco Corporation silicone Tensoactive
POLYCAT 77 - Air Product aminated Catalyst

The polyurethanes of Examples 4 to 6 were produced using isocyanate compositions in which the prepolymer was produced using a diol, that is having a functionality of 2. Expanded polyurethane foams produced from an isocyanate composition having a diol component in which there is essentially no cross linking provides excellent elongation properties but surprisingly, as the data in the Table illustrates, also provides excellent compression set and dynamic fatigue properties when measured under the stringent Peugeot Dynamic Fatigue test (200,000 cycles between 25 and 75% deflection at 3 Hz. Measurements 30 minutes after fatigue completion).

1. An isocyanate composition having an isocyanate functionality of 2.2 to 2.9 which comprises:
a) 20 to 80% by weight of the reaction product of methylene diphenyl isocyanate (MDI) with at least one polyether polyol comprising ethylene oxide (EO) and propylene oxide (PO) with a functionality of 2 to 8, an average molecular weight of 200 to 6000 and an ethylene oxide content of 20 to 90% by weight and in which said reaction product has a free NCO group content of 26 to 33% by weight; and
b) 10 to 80% by weight of a polymeric methylene diphenyl isocyanate having a general formula (I): 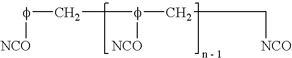
where Φ represents a phenyl group and n is a whole number greater than or equal to 1.

2. An isocyanate composition according to claim 1 which comprises 30 to 70% by weight of component a) wherein the at least one polyether polyol has an average molecular weight of 400 to 6000 and 10 to 70% by weight of component b) and 5 to 30% by weight of modified methylene diphenyl isocyanate uretonimine.

3. An isocyanate composition according to claim 1 in which the at least one polyether polyol comprises a mixture comprising a first polyether polyol having an average molecular weight of 1000 to 6000 and a second polyether polyol having an average molecular weight of less than 1000, wherein the first and second polyols, independently comprise ethylene oxide and propylene oxide with a functionality of 2 to 8, and an ethylene oxide content of 20 to 90% by weight and the second polyether polyol is present at a concentration of less than 50% by weight relative to the first polyol.

4. An isocyanate composition according to claim 1 in which the methylene diphenyl isocyanate comprises a mixture of the 4,4′ and 2,4′ MDI isomers, in which the 2,4′ isomer concentration is from 20% to 30% based on the total amount of MDI.

5. An isocyanate composition according to claim 1 in which the at least one polyether polyol comprises a polyether diol.

6. An isocyanate composition according to claim 5 in which the polyether diol has an ethylene oxide content of 50 to 75% or 80% and especially 70 to 80%.

7. An isocyanate composition according to claim 1 in which component a) comprises the reaction product of MDI comprising 20 to 30% of the 2,4′-MDI isomer and a polyether diol polyether diol having an ethylene oxide content of 70 to 80% in which the reaction product has a free NCO group content of 29 to 33%.

8. An isocyanate composition according to claim 1 in which the methylene diphenyl isocyanate and the polymeric methylene diphenyl isocyanate are both reacted with the at least one polyether polyol.

9. A process for the preparation of a flexible expanded polyurethane which comprises reacting together:
i) an isocyanate composition having an isocyanate functionality of 2.2 to 2.9 which comprises:
a) 20 to 80% by weight of the reaction product of methylene diphenyl isocyanate (MDI) with at least one polyether polyol comprising ethylene oxide (EO) and propylene oxide (PO) with a functionality of 2 to 8, an average molecular weight of 200 to 6000 and an ethylene oxide content of 20 to 90% by weight in which said reaction product has a free NCO group content of 26 to 33%; and
b) 20 to 80% by weight of a polymeric methylene diphenyl isocyanate having a general formula (I): 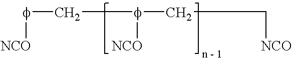
where Φ represents a phenyl group and n is a whole number greater than or equal to 1; and
ii) a polyol component comprising at least one polyol, with a functionality of 2 to 8 and an equivalent weight of 200 to 2000 and water.

10. A process according to claim 9 in which the isocyanate composition is as defined in claim 1.

11. A process according to claim 9 in which the isocyanate composition comprises a reaction product of MDI with 20 to 30% of the 2,4′-MDI isomer and a polyether diol having an ethylene oxide content of 70 to 80% in which the reaction product has a free NCO group content of 29 to 33%.

12. A process according to claim 9 in which, in i), the methylene diphenyl isocyanate and the polymeric methylene diphenyl isocyanate are both reacted with the at least one polyether polyol.

13. A process according to claim 12 in which at least one polyol and the polyol to be reacted with the isocyanate composition are the same and optionally the MDI and polymeric MDI are reacted with the polyether polyol to produce the expanded polyurethane in a single step.

14. A process according to claim 9 in which the water is between 3 and 6 parts by weight to 100 parts of the polyol component.

15. Use of an isocyanate composition according to claim 1 in the preparation of an expanded polyurethane having a density up to 50 Kg/m³, a bearing capacity greater than 40 N, according to ISO 2439-97, a % thickness loss of less than 5% and a % compression resistance loss of less than 16% when tested under Peugeot Test Method D42.1047-84.
